(19) United States
(12) Patent Application Publication
(10) Pub. No.: US 2025/0280854 A1
(43) Pub. Date: Sep. 11, 2025

(54) Pet Food Compositions

(71) Applicant: Hill's Pet Nutrition, Inc., Overland Park, KS (US)

(72) Inventors: Dayakar Venkata BADRI, Lawrence, KS (US); Kiran Mohan Sridhar PANICKAR, Lawrence, KS (US)

(73) Assignee: Hill's Pet Nutrition, Inc., Overland Park, KS (US)

(21) Appl. No.: 19/069,911

(22) Filed: Mar. 4, 2025

Related U.S. Application Data
(60) Provisional application No. 63/561,851, filed on Mar. 6, 2024.

(51) Int. Cl. A23K 10/22; A23K 50/42

(52) U.S. Cl. CPC A23K 10/22; A23K 50/42

(57) ABSTRACT

Pet food compositions, and particularly, pet food compositions comprising fish collagen hydrolysate are disclosed herein. Also disclosed herein are methods of treating an immune disorder, such as atopic dermatitis in a companion animal in need thereof and methods of alleviating at least one of pruritus, erythema, or alopecia in a companion animal with atopic dermatitis.

### CROSS-REFERENCE TO RELATED APPLICATION

This application claims the benefit of priority from U.S. Provisional Patent Application No. 63/561,851, filed 6 Mar. 2024, the contents of which are hereby incorporated herein by reference in its entirety.

### BACKGROUND

Inflammation and its associated proinflammatory mechanisms are part of an animal's immunological response to such challenges as disease or invading pathogens. Inflammation, which can be internal, external or both, sometimes occurs persistently and at levels that negatively impact the health of the animal. At times, the sustained and/or elevated production of proinflammatory substances including cytokines and chemokines may cause inflammation to work against the body's tissues and cause damage.

Inflammation can be classified as either acute or chronic. Acute inflammation is an initial response to harmful stimuli and is achieved by the increased movement of plasma and leukocytes from the blood into the injured tissues. A cascade of biochemical events propagates and matures the inflammatory response, involving the local vasculature, the immune system, and various cells within the injured tissue. Chronic inflammation, or prolonged inflammation, leads to a progressive shift in the type of cells that are present at the site of inflammation and is characterized by simultaneous destruction and healing of the tissue from the inflammatory process.

One inflammatory disorder is known as atopic dermatitis. Atopic dermatitis is a common type of chronic inflammatory skin disease found in pets and is one of the primary reasons for a veterinary visit. Typically, atopic dermatitis is characterized by pruritus (itchiness), erythema (redness), skin and ear secretions, and alopecia (hair loss). Thus, atopic dermatitis is considered to significantly reduce the quality of life for pets.

In addition to a reduced quality of life, pets suffering from atopic dermatitis often suffer from pruritic skin disorder and/or skin membrane barrier dysfunction. Skin barrier plays a critical role in preventing the entry of allergens and microorganisms into the body. The physical skin barrier is localized in the uppermost layer of the epidermis called stratum corneum. Further, the epidermis is continuously regenerated by terminally differentiating keratinocytes, a process called keratinization or cornification. Cornification begins with the migration of keratinocytes from the basal to upper layers during which keratinocytes also produce lipids and extrude them into the extracellular space to form extra-cellular enriched layers to maintain skin membrane barrier function. In addition, the presence of cytokines within the skin influences various processes of keratinocyte proliferation, differentiation and cornification.

It is believed that a combination of genetic, environmental, and immunological factors influence the pathogenesis of atopic dermatitis as well as the extent of the harm.

Despite ongoing research aimed at understanding inflammation and the role proinflammatory mechanisms play in tissue damage or disease progression, effective management of inflammatory conditions including atopic dermatitis has remained a challenge. Although a number of conventional treatments exist, such treatments have drawbacks including side effects, and may actually be harmful or make the condition worse. For example, steroids can fight inflammation by reducing the production of inflammatory components and are often prescribed for conditions including asthma, inflammatory bowel disease, and inflammatory arthritis. But steroids can have considerable side-effects and are one of the most frequently abused drugs in veterinary and human medicine.

There remains, therefore, a need for new or alternative methods and compositions for treating or preventing an inflammatory condition, including methods and compositions for treating pets suffering from atopic dermatitis and the effects thereof.

### BRIEF SUMMARY

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

Aspects of the disclosure are directed to pet food compositions and, particularly, pet food compositions comprising fish collagen hydrolysate. In accordance with a first aspect, provided is a pet food composition comprising fish collagen hydrolysate in an amount ranging from about 0.5% to about 5%, such as from about 1% to about 3%, or about 2%, by weight based on the total weight of the pet food composition. In certain embodiments, the pet food composition comprises about 2% fish collagen hydrolysate, by weight based on the total weight of the pet food composition. In certain embodiments, the pet food composition comprises at least one of glycine present in an amount greater than about 0.7%, hydroxyproline present in an amount greater than about 0.1%, or proline present in an amount greater than about 0.7%, wherein all weights are based on the total weight of the pet food composition. In certain embodiments, the pet food composition is a dog food composition. According to certain embodiments, the pet food composition is a nutritionally complete diet, and in certain embodiments, the pet food composition is a treat or a supplement to a nutritionally complete diet.

According to another aspect, disclosed herein is a method of treating an immune disorder in a companion animal in need thereof, the method comprising administering to the companion animal a pet food composition comprising an effective amount of collagen hydrolysate, such as fish collagen hydrolysate. In certain embodiments of the methods, the fish collagen hydrolysate is present in the pet food composition an amount ranging from about 0.5% to about 5%, such as from about 1% to about 3%, or about 2%, by weight based on the total weight of the pet food composition. According to certain embodiments, the immune disorder is atopic dermatitis, and in certain embodiments, the atopic dermatitis is characterized by at least one of pruritus, erythema, alopecia, ear secretions, or skin secretions.

In certain embodiments of the methods disclosed herein, the method decreases expression of at least one gene selected from PLAUR, TSC2, ITGAX, ITGB2, or PRKCE in the companion animal, and in certain embodiments, the method decreases expression of at least two, such as at least 3, at least 4, or 5 genes selected from PLAUR, TSC2, ITGAX, ITGB2, or PRKCE in the companion animal. According to certain embodiments of the disclosure, the method increases expression of at least one gene selected from CD83 or S100A3 in the companion animal, and according to certain embodiments, the method increases trans-4-hydroxyproline in the companion animal.

In accordance with a further aspect of the disclosure, the methods disclosed herein improves cutaneous would healing in the companion animal, and in certain aspects of the disclosure, the methods disclosed herein improve hair follicle regeneration in the companion animal. According to certain embodiments, the companion animal is a dog.

Also disclosed herein is a method of treating cancer in a companion animal in need thereof, the method comprising orally administering to the companion animal a pet food composition comprising an effective amount of fish collagen hydrolysate. In certain embodiments, the companion animal in need thereof is undergoing immune checkpoint inhibitor therapy.

According to certain embodiments, there is disclosed herein a method of alleviating at least one pruritus, erythema, or alopecia in a companion animal with atopic dermatitis, the method comprising orally administering to the companion animal (e.g., a dog) a pet food composition disclosed herein.

In certain embodiments of the methods disclosed herein, the method may include orally administering to the companion animal the pet food composition as disclosed herein at least once a day for at least one day, such at least 5 days, at least 7 days, at least 10 days, at least 14 days, at least 28 days, or at least 42 days.

### BRIEF DESCRIPTION OF THE DRAWINGS

The features and advantages of aspects of the disclosure will be apparent from the following more detailed description of certain embodiments of the disclosure and as illustrated in the accompanying drawings in which:

FIGS. 1A-1C are bar graphs showing the improvement in pruritus (FIG. 1A), erythema (FIG. 1B), and alopecia (FIG. 1C) exhibited by dogs consuming a control pet food composition and dogs consuming a test pet food composition, as disclosed in Example 2.

FIG. 2 is a graph showing box and whisker plots of PLAUR gene expression levels in dogs at baseline, in dogs consuming a positive control pet food composition, and in dogs consuming a test pet food composition, as disclosed in Example 4.

FIG. 3 is a graph showing box and whisker plots of TSC2 gene expression levels in dogs at baseline, in dogs consuming a positive control pet food composition, and in dogs consuming a test pet food composition, as disclosed in Example 4.

FIG. 4 is a graph showing box and whisker plots of ITGAX gene expression levels in dogs at baseline, in dogs consuming a positive control pet food composition, and in dogs consuming a test pet food composition, as disclosed in Example 4.

FIG. 5 is a graph showing box and whisker plots of ITGB2 gene expression levels in dogs at baseline, in dogs consuming a positive control pet food composition, and in dogs consuming a test pet food composition, as disclosed in Example 4.

FIG. 6 is a graph showing box and whisker plots of PRKCE gene expression levels in dogs at baseline, in dogs consuming a positive control pet food composition, and in dogs consuming a test pet food composition, as disclosed in Example 4.

FIG. 7 is a graph showing box and whisker plots of CD83 gene expression levels in dogs at baseline, in dogs consuming a positive control pet food composition, and in dogs consuming a test pet food composition, as disclosed in Example 4.

FIG. 8 is a graph showing box and whisker plots of S100A4 gene expression levels in dogs at baseline, in dogs consuming a positive control pet food composition, and in dogs consuming a test pet food composition, as disclosed in Example 4.

FIG. 9 is a graph showing box and whisker plots of circulating levels of trans-4-hydroxyproline in dogs consuming a positive control pet food composition and in dogs consuming a test pet food composition, as disclosed in Example 4.

FIG. 10 is a schematic diagram illustrating how the pet food composition disclosed herein alters gene expression of PLAUR, ITGAX, ITGB2, PRKCE, CD83, S100A4, and TSC2, wherein PLAUR, ITGAX, ITGB2, and PRKCE affect immune regulation functions; S100A4 and TSC2 affect hair follicle regeneration, and CD83 affects all of immune regulation, cutaneous wound healing, and hair follicle regeneration.

It should be understood that the various aspects of the disclosure are not limited to the compositions, arrangements, and instrumentality shown in the figures.

### DETAILED DESCRIPTION

For illustrative purposes, the principles of the present disclosure are described by referencing various exemplary embodiments thereof. Although certain embodiments of the disclosure are specifically described herein, one of ordinary skill in the art will readily recognize that the same principles are equally applicable to and can be employed in other compositions and methods. Before explaining the disclosed embodiments in detail, it is to be understood that the disclosure is not necessarily limited in its application to the details of any particular embodiment disclosed. The terminology used herein is for the purpose of description and not of limitation.

As used herein and in the appended claims, the singular forms “a”, “an”, and “the” include plural references unless the context dictates otherwise. The singular form of any class of the ingredients refers not only to one ingredient within that class, but also to a mixture of those ingredients. The terms “a” (or “an”), “one or more” and “at least one” may be used interchangeably herein. The terms “comprising”, “including”, and “having” may be used interchangeably. The term “include” should be interpreted as “include, but are not limited to”. The term “including” should be interpreted as “including, but are not limited to”.

As used throughout, ranges are used as shorthand for describing each and every value that is within the range. Any value within the range can be selected as the terminus of the range. Thus, a range from 1-5, includes specifically 1, 2, 3, 4 and 5, as well as subranges such as 2-5, 3-5, 2-3, 2-4, 1-4, etc. The term “about” when referring to a number means any number within a range of 10% of the number. For example, the phrase “about 2 wt %” refers to a number between and including 1.8 wt % and 2.2 wt %.

All references cited herein are hereby incorporated by reference in their entireties. In the event of a conflict in a definition in the present disclosure and that of a cited reference, the present disclosure controls.

The abbreviations and symbols as used herein, unless indicated otherwise, take their ordinary meaning. The abbreviation “wt. %” or “wt %” means percent by weight with respect to the pet food composition. The symbol ““ ” refers to a degree, such as a temperature degree or a degree of an angle. The symbols “h”, “min”, “mL”, “nm”, “μm” means hour, minute, milliliter, nanometer, and micrometer, respectively. The abbreviation “UV-VIS” referring to a spectrometer or spectroscopy, means Ultraviolet-Visible. The abbreviation “rpm” means revolutions per minute.

Any member in a list of species that are used to exemplify or define a genus, may be mutually different from, or overlapping with, or a subset of, or equivalent to, or nearly the same as, or identical to, any other member of the list of species. Further, unless explicitly stated, such as when reciting a Markush group, the list of species that define or exemplify the genus is open, and it is given that other species may exist that define or exemplify the genus just as well as, or better than, any other species listed.

All components and elements positively set forth in this disclosure can be negatively excluded from the claims. In other words, the pet food compositions of the instant disclosure can be free or essentially free of all components and elements positively recited throughout the instant disclosure. In some instances, the pet food compositions of the present disclosure may be substantially free of non-incidental amounts of the ingredient(s) or compound(s) described herein. A non-incidental amount of an ingredient or compound is the amount of that ingredient or compound that is added into the pet food composition by itself. For example, a pet food composition may be substantially free of a non-incidental amount of an ingredient or compound, although such ingredient(s) or compound(s) may be present as part of a raw material that is included as a blend of two or more compounds. Substantially free, unless other defined or described herein, typically refers to an ingredient or compound in an amount of about 2 wt % or less, about 1.5 wt % or less, about 1 wt % or less, about 0.5 wt % or less, about 0.1 wt % or less, or about 0.05 wt % or less, or about 0.01 wt % or less, based on the total weight of the pet food composition on a dry matter basis.

Some of the various categories of components identified may overlap. In such cases where overlap may exist and the pet food composition includes both components (or the composition includes more than two components that overlap), an overlapping compound does not represent more than one component. For example, certain components or ingredients may be characterized as both an ancient grain and an amaranth. If a particular pet food care composition recites both an ancient grain and an amaranth, a compound that may be characterized as both an ancient grain and an amaranth will serve only as either an ancient or an amaranth—not both.

As used herein, the term “pet” could be used interchangeably with “companion animal” and refers to an animal of any species kept by a caregiver as a pet or any animal of a variety of species that have been widely domesticated as pets, including canines (Canis familiaris) and felines (Felis domesticus). Thus, a pet may include but is not limited to, working dogs, pet dogs, cats kept for rodent control (i.e., farm cats), pet cats, ferrets, birds, reptiles, rabbits, and fish.

To the extent that food and food ingredients contain water/moisture, the dry matter represents everything in the sample other than water including, for example, protein, fiber, fat, carbohydrates, minerals, etc. Dry matter weight is the total weight minus the weight of any water. The skilled artisan would readily recognize and understand nutritional amounts and percentages expressed as dry matter amounts, dry matter weights and dry matter percentages.

Dry matter intake per day is calculated as the total nutritional intake per day excluding all water. For example, an amount of an ingredient equal to a specific percent of daily nutritional intake refers to the amount of that ingredient in dry matter form (i.e., excluding all water) relative to the total amount of dry matter consumed (also excluding all water) in a day.

“Daily nutritional intake” and “total nutritional intake per day” refer to dry matter intake per day. That is, water weight is not included in calculating the amount of nutrition consumed per day. To calculate percent of an ingredient of total daily intake on a dry matter basis, water is removed from the total intake to give total daily dry matter intake and the percentage of the ingredient is based on amount of ingredient present as dry matter.

As used herein, an “ingredient” refers to any component of a pet food composition. The term “nutrient” refers to a substance that provides nourishment and thus has a nutrient value. In some cases, an ingredient may comprise more than one “nutrient,” for example, a composition may comprise corn comprising important nutrients including both protein and carbohydrate.

Aspects of the disclosure are directed to pet food compositions and, particularly, pet food compositions comprising fish collagen hydrolysate. In certain embodiments, the pet food composition disclosed herein comprises an effective amount of fish collagen hydrolysate, wherein the amount is effect in treating and/or alleviating the symptoms of at least one immune disorder, such as atopic dermatitis.

Collagen is an abundant protein in most mammal bodies and is a major building block of ligaments, tendons, bones, muscles, and skin tissue. Collagen protein may be broken down into smaller molecules through the process of hydrolyzation with water, first forming gelatin (partially hydrolyzed collagen), and then after enzymatic hydrolysis, forming hydrolyzed collagen or collagen hydrolysate. The smaller molecules of collagen hydrolysate may be easily absorbed by the body into the blood stream when consumed orally, and then carried to the dermis, where the collagen hydrolysate may stimulate the multiplication and motility of fibroblasts, increase collagen production, and increase hyaluronic acid production. Collagen hydrolysate may originate from several different collage sources, such as collagenous tissues in the bones, skin, and connective tissues of animals including cattle, horses, pigs, chickens, goats, sheep, and fish.

The pet food compositions disclosed herein typically comprise fish collagen hydrolysate. It was surprisingly discovered that pet food compositions having fish collagen hydrolysate unexpectedly achieved reductions in symptoms associated with atopic dermatitis in canines consuming such pet food compositions.

In certain embodiments disclosed herein, the pet food composition comprises collagen hydrolysate, and in certain embodiments the collagen hydrolysate is fish collagen hydrolysate. In certain embodiments, the pet food composition comprises collagen hydrolysate, such as fish collagen hydrolysate, in an amount ranging from about 0.1 wt % to about 10 wt %, based on the total weight of the pet food composition. In certain embodiments, the pet food composition comprises collagen hydrolysate, such as fish collagen hydrolysate, in an amount ranging from about 0.5 wt % to about 8 wt %, such as from about 1% to about 5 wt %, from about 1.5 wt % to about 3 wt %, or about 2 wt %, based on the total weight of the pet food composition.

In certain embodiments of the disclosure, the amount(s) of various amino acids may be altered in the pet food composition due to the incorporation of fish collagen hydrolysate as compared to a composition that does not contain fish collage hydrolysate or a composition that contains a different amount of fish collagen hydrolysate. In certain embodiments, the pet food composition disclosed herein comprises at least one glycine, hydroxyproline, or proline, and in certain embodiments, the pet food composition disclosed herein comprises all three of glycine, hydroxyproline, and proline.

According to various embodiments of the disclosure, the pet food composition disclosed herein may comprise at least about 0.7 wt % glycine, such as greater than about 0.7 wt %, greater than about 0.8 wt %, greater than about 0.9 wt %, greater than about 1.0 wt %, or greater than about 1.1 wt %, based on the total weight of the pet food composition. In certain embodiments, the pet food composition disclosed herein may comprise glycine in an amount ranging from about 0.7 wt % to about 2 wt %, such as about 0.8 wt % to about 1.5 wt %, or about 0.9 wt % to about 1.1 wt %, based on the total weight of the pet food composition. According to certain embodiments, the pet food composition disclosed herein may comprise at least about 0.7 wt % proline, such as greater than about 0.7 wt %, greater than about 0.8 wt %, greater than about 0.9 wt %, greater than about 1.0 wt %, or greater than about 1.1 wt %, based on the total weight of the pet food composition. In certain embodiments, the pet food composition disclosed herein may comprise proline in an amount ranging from about 0.7 wt % to about 2 wt %, such as about 0.8 wt % to about 1.5 wt %, or about 0.8 wt % to about 1.0 wt %, based on the total weight of the pet food composition. In certain embodiments, the pet food composition disclosed herein may comprise at least about 0.07 wt % hydroxyproline, such as greater than about 0.07 wt %, greater than about 0.08 wt %, greater than about 0.09 wt %, greater than about 0.1 wt %, greater than about 0.11 wt %, greater than about 0.12 wt %, or greater than about 0.13 wt %. In certain embodiments, the pet food composition disclosed herein may comprise hydroxyproline in an amount ranging from about 0.07 wt % to about 1 wt %, such as from about 0.09 wt % to about 0.2 wt %, or from about 0.1 wt % to about 0.15 wt %.

Also disclosed herein is a method of treating an immune disorder and/or alleviating symptoms of an immune disorder in a companion animal, the method comprising administering an effective amount of the pet food composition disclosed herein to a companion animal in need thereof, such as a companion animal that has been diagnosed with an immune disorder. Also disclosed herein are methods of diagnosing an immune disorder in a companion animal, the method comprising measuring expression of at least two genes, such as at least 3, at least 4, at least 5, at least 6 or 7 genes selected from PLAUR, TSC2, ITGAX, ITGB2, PRKCE, CD83, or S100A3 in a biological sample from the companion animal; and identifying the companion animal as having an immune disorder (e.g., atopic dermatitis) if expression of the measured genes is significantly different (e.g., significantly increased or significantly decreased) from expression of a control.

In certain embodiments, disclosed herein is a method of treating an immune disorder in a companion animal, the method comprising measuring expression of at least two genes, such as at least 3, at least 4, at least 5, at least 6 or 7 genes selected from PLAUR, TSC2, ITGAX, ITGB2, PRKCE, CD83, or S100A3 in a companion animal; identifying the companion animal as having an immune disorder (e.g., atopic dermatitis) if expression of the measured genes is significantly different (e.g., significantly increased or significantly decreased) from expression of a control; and administering to the companion animal an effective amount of the pet food composition disclosed herein.

In certain embodiments of the disclosure, the immune disorder is selected from inflammatory bowel disease, arthritis (e.g., rheumatoid arthritis, osteoarthritis), atopic dermatitis, periodontal disease, pancreatitis, allergic reactions, otitis, autoimmune diseases, and bladder diseases. In certain embodiments, of the disclosure, the immune disorder is atopic dermatitis. Symptoms of atopic dermatitis that may be treated and/or alleviated by the methods disclosed herein include, for example, pruritus (itching), erythema (redness), skin lesions, alopecia (hair loss), licking and chewing of paws, secondary skin infections, ear infections, ear secretions, and skin secretions.

In accordance with a further aspect of the disclosure, a method is provided for treating, preventing and/or alleviating the symptoms of pruritus, erythema, alopecia, or skin and car secretion in atopic dermatitis canine, the method comprising administering a pet food composition disclosed herein.

In certain embodiments, the control may be any suitable reference that allow evaluation of the expression level of the genes in the biological sample (e.g., blood, saliva, or urine) as compared to the expression of the same genes in a control sample. The control may be a sample from an animal or a pool of animals that do not have an immune disorder and/or are otherwise considered healthy, or the control can be a pre-determined threshold value of absolute expression.

The methods disclosed herein may include administering an animal (e.g., canine) in need thereof a pet food composition disclosed herein. In some instances, the method may include providing and/or feeding the animal the pet food compositions for 1 or more days, preferably 5 or more days, preferably 7 or more days, preferably 10 or more days, preferably 14 or more days, preferably 30 or more days, or preferably 42 or more days. The method may include feeding the animal one time a day, two times a day, three times a day, or in some embodiments four or more times a day.

### Gene Expression

In certain embodiments disclosed herein, administration of a pet food composition comprising fish collagen hydrolysate as disclosed herein to a pet in need thereof alters gene expression of at least one gene known to be implicated in immune disorders such as atopic dermatitis. In certain embodiments, administration of the pet food compositions disclosed herein to a pet in need thereof alters gene expression of at least one gene known to be implicated in pruritus, erythema, and/or alopecia, and in certain embodiments, administration of the pet food compositions disclosed herein to a pet in need thereof alters gene expression of at least one gene known to be implicated in immune regulation, cutaneous would healing, and/or hair follicle regeneration.

The nucleic acid sequences of the genes disclosed herein and their variants and the amino acid sequences encoded by the same are publicly available. The genes are described below in Table A as reported for the Canis lupus familiaris (dog) species. Where available, Vertebrate Gene Nomenclature Committee (VGNC) annotations are used to describe the genes discussed herein. The following Table A lists the VGNC annotations, and gene name descriptions for the genes discussed herein.

TABLE A
VGNC Gene Identification Numbers and Description

| | VGNC | NCBI | |
|---|---|---|---|
| | Gene ID | Gene | |
| Gene name | No. | No. | Description |
| PLAUR | 56920 | 476446 | Plasminogen activator, |
| | | | urokinase receptor |
| ITGAX | 42135 | 489929 | Integrin subunit alpha X |
| (CD11c) | | | |
| ITGB2 | 42139 | 403770 | Integrin subunit beta 2 |
| (CD18) | | | |
| PRKCE | 44980 | 609934 | Protein kinase C epsilon |
| CD83 | 38977 | 610141 | CD83 molecule |
| S100A4 | 45830 | 403787 | S100 calcium binding protein A4 |
| TSC2 | 47891 | 479883 | TSC complex subunit 2 |

In certain embodiments, administration of a pet food composition comprising fish collagen hydrolysate as disclosed herein decreases expression of plasminogen activator, urokinase receptor (PLAUR) in a pet as compared to a baseline. PLAUR is a membrane-bound receptor expressed in immunologically-active cell membranes and plays a role in various physiological and pathological processes, specifically in inflammation and immune responses. In addition, PLAUR is considered a low-grade inflammation marker for predicting the status of the immune system. There is evidence that PLAUR levels are elevated in atopic keratinocytes (Mathay et al., 2011) and in infants with atopic dermatitis conditions when compared with healthy controls (Nousbeck et al., 2023). PLAUR signaling promotes chronic pruritus (Chen et al., 2022). PLAUR is also involved in various physiological and pathological processes, as demonstrated in a study that showed low PLAUR levels are associated with higher median overall survival of cancer patients before or during immune checkpoint inhibitor therapy (Loosen et al., 2021).

In certain embodiments, administration of a pet food composition comprising fish collagen hydrolysate as disclosed herein significantly decreases expression of integrin alpha subunit X (ITGAX) compared to a baseline. ITGAX, also called CD11c, is a marker for dendritic cells. Dendritic cells are antigen-presenting cells that participate in the pathogenesis of canine atopic dermatitis similar to human atopic dermatitis. Without wishing to be bound by theory, it is believed that harnessing dendritic cells may alleviate skin inflammation. In addition, dermal dendritic cells express IL-31 to activate sensory neurons and stimulate wound itching (Xu et al 2020).

In certain embodiments, administration of a pet food composition comprising fish collagen hydrolysate as disclosed herein significantly decreases expression of integrin subunit beta 2 (ITGB2) compared to a baseline. ITGB2, also called CD18, is a complex leukocyte-specific adhesion molecule involved in leukocyte trafficking and other immunological processes, such as immune suppression through restricted Toll-like receptor (TLR) signaling, dendritic cell migration, and B cell receptor (BCR) signaling (Fagerholm et al., 2019). In addition, it has been reported the expression of ITGB2 surface molecules is significantly higher in atopic dermatitis dogs as well as atopic dermatitis dogs with purulent dermatitis compared with healthy dogs, wherein the levels vary depending upon the stage of the disease (Taszkun, 2014). Further, ITGB2 controls the development and activation of monocytes to macrophages, which are known to accumulate in acute and chronic inflamed skin.

In certain embodiments, administration of a pet food composition comprising fish collagen hydrolysate as disclosed herein significantly decreases expression of protein kinase C epsilon (PRKCE) compared to a baseline. Protein Kinase C is a phospholipid-dependent serine/threonine kinase protein having 11 isoforms and involved in inflammation and immune mediated disorders (Webb et al., 2000; Aksoy et al., 2004). The PRKCE isoform is an isoform found to be a component of the TLR-4 signaling pathway and playing a key role in macrophage and dendritic cell activation in response to lipopolysaccharides. PRKCE has been found to be overexpressed in tumor-derived cell lines and histopathological tumor specimens, suggesting that PRKCE is involved in establishing an aggressive metastatic phenotype (Gorin & Pan, 2009). A recent study demonstrated that PRKCE overexpression is positively associated with acute myeloid leukemia exhibiting poor outcomes by promoting daunorubicin drug resistance through p-glycoprotein mediated drug efflux (Nicholson et al., 2022).

In certain embodiments, administration of a pet food composition comprising fish collagen hydrolysate as disclosed herein significantly increases expression of CD83 compared to a baseline. In recent years, CD83 has emerged as a potential candidate for “pro-resolution” therapy for chronic inflammatory diseases (Peckert-Maier et al., 2022). CD83 occurs in a membrane-bound and a soluble isoform, and both are involved in the resolution of inflammation. It has been shown that administration of soluble CD83 (sCD83) reduced skin inflammation and development of allergy contact dermatitis in a mouse model of dermatitis (Mihatsch et al., 2016). Another study demonstrated the role of soluble CD83 in accelerating and improving cutaneous wound healing process by the induction of pro-resolving macrophages through systemic as well as topical application (Royzman et al., 2022). In addition, soluble CD83 has been marketed as topical treatment for hair loss.

In certain embodiments, administration of a pet food composition comprising fish collagen hydrolysate as disclosed herein significantly increases expression of S100 calcium binding protein A4 (S100A4) compared to a baseline. S100A4 is a member of the calcium binding S100 protein family. It has been reported that S100A4 upregulated in the epithelial sac of bulge and dermal papillae region to activate the stem cells at the onset of follicle regeneration prior to entering anagen phase of hair cycle growth (Ito & Kazawa, 2001). In addition, S100A4 activates mTOR signaling in colorectal cancer cells (Wang et al., 2014).

In certain embodiments, administration of a pet food composition comprising fish collagen hydrolysate as disclosed herein significantly decreases expression of TSC complex subunit 2 (TSC2) compared to a baseline. TSC2 acts a negative regulator of mTORC1 signaling, implying that the down-regulation of TSC2 increases activity of mTORC1 signaling, which is necessary for the activation and entry of hair follicle stem cells (HFSCs) into the anagen phase of hair growth (Tu et al., 2023; Deng et al., 2015). Anagen phase begins when the HFSCs obtain sufficient cues to overcome suppressive signals from their niche cells to progress cell proliferation and hair growth.

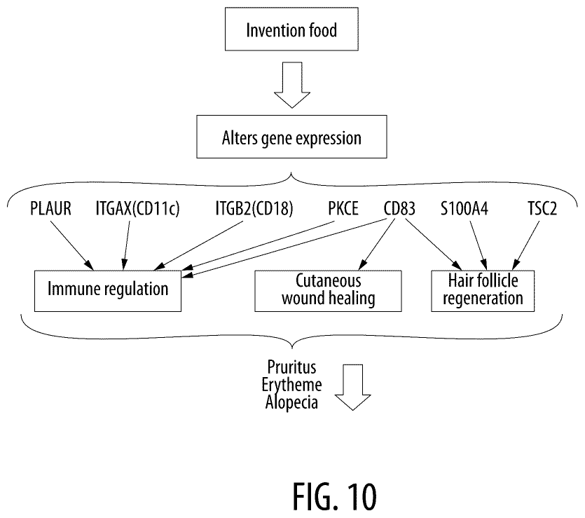

As shown in FIG. 10, decreasing expression of at least one of PLAUR, ITGAX, ITGB2, or PRKCE and/or increasing expression of CD83 can affect immune regulation, in turn leading to improvement in symptoms of atopic dermatitis, such as pruritus, erythema, and/or alopecia. Likewise, increasing expression of CD83 may improve cutaneous wound healing, in turn leading to improvement in symptoms of atopic dermatitis, such as pruritus, erythema, and/or alopecia. Finally, increasing expression of at least one CD83 or S100A4 and/or decreasing expression of TSC2 may improve hair follicle regeneration, in turn leading to improvements in symptoms of atopic dermatitis, such as pruritus, erythema, and/or alopecia

In certain embodiments, administration of a pet food composition comprising fish collagen hydrolysate as disclosed herein to a pet in need thereof alters gene expression of at least one gene, such as at least 2, at least 3, at least 4, at least 5, at least 6, or 7 of the genes selected from PLAUR, ITGAX, ITGB2, PRKCE, CD83, S100A4, or TSC2. In certain embodiments, administration of a pet food composition comprising fish collagen hydrolysate as disclosed herein to a pet in need thereof decreases expression of at least one gene, such as at least 2, at least 3, at least 4, or 5 of the genes selected from PLAUR, ITGAX, ITGB2, PRKCE, or TSC2, and in certain embodiments, administration of the pet food composition increases expression of at least one or both of the genes selected from CD83 or S100A4.

Treatment and/or alleviation of symptoms associated with atopic dermatitis may be measured by any means known in the art. In certain embodiments, the efficacy of a treatment or the alleviation of symptoms may be measured by a veterinarian, and in certain embodiments, the efficacy of a treatment or the alleviation of symptoms may be measured by a caregiver of the companion animal receiving the pet food composition. In certain embodiments, the pet food compositions disclosed herein improves the symptoms of atopic dermatitis (e.g., pruritus, erythema, and/or alopecia) by at least about 5%, at least about 10%, at least about 15%, at least about 20%, at least about 25%, at least about 30%, at least about 35%, at least about 40%, at least about 45%, at least about 50%, at least about 55%, or at least about 60%.

In certain embodiments of the method disclosed herein, the pet food composition may be administered together with an additional treatment method, e.g., topical and/or oral medication.

### Pet Food Compositions

In accordance with one aspect of the disclosure, in addition to collagen hydrolysate, the pet food composition may further comprise at least one ingredient believed to treat an immune disorder in the companion animal and/or other ingredients known for use in a pet food composition.

In certain embodiments, the pet food composition disclosed herein may be a nutritionally complete diet. A “nutritionally complete diet” may be a diet that may include sufficient nutrients for maintenance of normal health of a healthy animal on the dict. In certain aspects, the pet food composition(s) disclosed herein may be a nutritionally complete diet, and in certain embodiments, the pet food composition may not be a nutritionally complete diet, but may be used to supplement an animal's otherwise nutritionally complete diet, e.g., as a treat or a supplement. In certain embodiments, the pet food composition may be blended with a nutritionally complete diet and/or balanced food diet.

According to another aspect of the disclosure, provided is a pet food composition that including a fat; a protein; fiber; ash; and carbohydrate. For example, a nutritionally complete and balanced pet food composition may comprise: about 0 to about 90%, preferably about 5% to 60%, by weight of carbohydrates; about 5% to about 70%, preferably about 10% to about 60%, more preferably about 20% to about 50%, by weight of protein: about 1% to about 50%, preferably about 2% to about 40%, more preferably about 3% to about 15%, by weight of fat; about 0.1% to about 40%, preferably about 1% to about 30%, more preferably about 15% to about 50%, by weight of total dietary fiber; about 0 to about 15%, preferably about 2% to about 8%, by weight of vitamins and minerals, antioxidants, and other nutrients which support the nutritional needs of the animal.

Suitable components, such as those listed herein, may be included or excluded from the formulations for the pet food compositions depending on the specific combination of other ingredients and the form of the pet food compositions. In some embodiments, the pet food compositions disclosed herein may be in the form of a standalone pet food, as a supplement to pet food, as a pet food treat, or the like.

The pet food compositions are formulated to include fat in an amount that may vary, but typically is in the range of about 8 to about 50 wt %, endpoints included, based on the total weight of the pet food composition on a dry matter basis. For example, the pet food composition may include fat in an amount ranging from about 10 to about 50 wt %, about 12 to about 50 wt %, about 14 to about 50 wt %, about 16 to about 50 wt %, about 18 to about 50 wt %, about 20 to about 50 wt %, about 22 to about 50 wt %, about 24 to about 50 wt %; from about 8 to about 40 wt %, about 10 to about 40 wt %, about 12 to about 40 wt %, about 14 to about 40 wt %, about 16 to about 40 wt %, about 18 to about 40 wt %, about 20 to about 40 wt %, about 22 to about 40 wt %, about 24 to about 40 wt %; from about 8 to about 35 wt %, about 10 to about 35 wt %, about 12 to about 35 wt %, about 14 to about 35 wt %, about 16 to about 35 wt %, about 18 to about 35 wt %, about 20 to about 35 wt %, about 22 to about 35 wt %, about 24 to about 35 wt %; about 8 to about 30 wt %, about 10 to about 30 wt %, about 12 to about 30 wt %, about 14 to about 30 wt %, about 16 to about 30 wt %, about 18 to about 30 wt %, about 20 to about 30 wt %, about 22 to about 30 wt %, about 24 to about 30 wt %; from about 8 to about 27 wt %, about 10 to about 27 wt %, about 12 to about 27 wt %, about 14 to about 27 wt %, about 16 to about 27 wt %, about 18 to about 27 wt %, about 20 to about 27 wt %, about 22 to about 27 wt %; from about 8 to about 24 wt %, about 10 to about 24 wt %, about 12 to about 24 wt %, about 14 to about 24 wt %, about 16 to about 24 wt %, about 18 to about 24 wt %, about 20 to about 24 wt %; from about 8 to about 22 wt %, about 10 to about 22 wt %, about 12 to about 22 wt %, about 14 to about 22 wt %, about 16 to about 22 wt %, about 18 to about 22 wt %; from about 8 to about 22 wt %, about 10 to about 22 wt %, about 12 to about 22 wt %, about 14 to about 22 wt %, about 16 to about 22 wt %, about 18 to about 22 wt %; from about 8 to about 20 wt %, about 10 to about 20 wt %, about 12 to about 20 wt %, about 14 to about 20 wt %, about 16 to about 20 wt %, including ranges and subranges thereof, based on the total weight of the pet food composition on a dry matter basis.

The term “fat” generally refers to a lipid or mixture of lipids that may generally be a solid or a liquid at ordinary room temperatures (e.g., 25° C.) and pressures (e.g., 1 atm). In some instances, the fat may be a viscous liquid or an amorphous solid at standard room temperature and pressure. The fat may be incorporated completely within the food composition, deposited on the outside of the pet food composition, or a mixture of the two methods.

The fat may comprise dietary fats, such as triglycerides. In some embodiments, the triglyceride may comprise about 20 to about 100%, about 40 to about 100%, about 50 to about 100%, about 60 to about 100%, about 70 to about 100%, about 80 to about 100%, about 90 to about 100%, of the total amount of fat in the pet food composition. In further embodiments, the triglyceride comprises about 20 to about 95%, about 40 to about 95%, about 50 to about 95%, about 60 to about 95%, about 70 to about 95%, about 80 to about 95%, about 90 to about 95%, of the total amount of fat in the pet food composition. In additional embodiments, the triglyceride comprises about 20 to about 90%, about 40 to about 90%, about 50 to about 90%, about 60 to about 90%, about 70 to about 90%, about 80 to about 90%, of the total amount of fat in the pet food composition. In yet further embodiment, the triglyceride comprises about 20 to about 80%, about 40 to about 80%, about 50 to about 80%, about 60 to about 80%, about 70 to about 80%, of the total amount of fat in the pet food composition.

The triglyceride may include one or more constituents that comprise a fatty acid(s) component/moiety. For example, the triglyceride may include one, two, or three aplanatic chains that are selected from fatty acid component. Non-limiting examples of fatty acid components include, but are not limited to, omega-3 fatty acids, omega-6 fatty acids, lauric acid, myristic acid, palmitic acid, palmitoleic acid, margaric acid, margaroleic acid, stearic acid, oleic acid, stearidonic acid, gadoleic acid, behenic acid, erucic acid, docosatetraenoic acid, and a combination of two or more thereof. The fatty acid(s) moieties may be a polyunsaturated fatty acid, such as an omega-3 fatty acid, an omega-6 fatty acid, or a combination of two or more thereof. Non-limiting examples of omega-3 fatty acid components include those selected from linolenic acid, stearidonic acid, eicosatetraenoic acid, eicosapentaenoic acid, docosapentaenoic acid, docosahexaenoic acid, and a combination of two or more thereof. Examples of omega-6 fatty acid moieties include linolenic acid, calendic acid, eicosadienoic acid, arachidonic acid, docosadienoic acid, adrenic acid, osbond acid, tetracosatetraenoic acid, tetracosapentaenoic acid, or a combination of two or more thereof.

The triglyceride may be selected from triglycerides having at least one aliphatic carbon chain comprised of 6 to 10 carbons. For example, the triglyceride may have one, two, or three aliphatic carbons chains of 6 to 10 carbons. In some embodiments, the triglyceride has an aliphatic carbon chain of 6 carbons, 7 carbons, 8 carbons, 9 carbons, and/or 10 carbons. For example, the aliphatic carbon chain of the medium chain triglyceride may include from 6 to 9 carbons, 6 to 8 carbons, 6 or 7 carbons; 7 to 10 carbons, 7 to 9 carbons, 7 or 8 carbons; 8 to 10 carbons, or 8 or 9 carbons, or 9 or 10 carbons. In some embodiments, the triglyceride(s) comprises an aliphatic carbon chain having 6 carbons, 8 carbons, or 10 carbons. For example, the triglyceride may have an aliphatic carbon chain selected from caprylate, caprate, and/or decanoate.

The pet food compositions may optionally contain one or more fatty acid(s). Non-limiting examples of fatty acids include, but are not limited to, omega-3 fatty acids, omega-6 fatty acids, lauric acid, myristic acid, palmitic acid, palmitoleic acid, margaric acid, margaroleic acid, stearic acid, oleic acid, stearidonic acid, gadoleic acid, behenic acid, crucic acid, docosatetraenoic acid, and a combination of two or more thereof. The fatty acid(s) may be a polyunsaturated fatty acid, such as an omega-3 fatty acid, an omega-6 fatty acid, or a combination of two or more thereof. Non-limiting examples of omega-3 fatty acids include those selected from linolenic acid, stearidonic acid, eicosatetraenoic acid, eicosapentaenoic acid, docosapentaenoic acid, docosahexaenoic acid, and a combination of two or more thereof. The pet food composition may include linolenic acid, eicosapentaenoic acid, docosahexaenoic acid, or a combination of two or more thereof. In at least one embodiment, the pet food composition comprises alpha-linolenic acid and/or gamma-linolenic acid. Additionally or alternatively, the polyunsaturated fatty acid may comprise an omega-6 fatty acids. Examples of omega-6 fatty acid include linolenic acid, calendic acid, eicosadienoic acid, arachidonic acid, docosadienoic acid, adrenic acid, osbond acid, tetracosatetraenoic acid, tetracosapentaenoic acid, or a combination of two or more thereof. In some embodiments, the polyunsaturated fatty acid comprises an omega-6 fatty acid selected from linolenic acid, arachidonic acid, and a combination of two or more thereof.

The pet food composition may be formulated to have a weight ratio of omega-3 fatty acids to omega-6 fatty acids of from about 0.5:1 to about 7:1. In some embodiments, the pet food composition has a weight ratio of omega-3 fatty acids to omega-6 fatty acids of from about 0.5:1 to about 6:1, about 0.5:1 to about 5:1, about 0.5:1 to about 4:1, about 0.5:1 to about 3:1, about 0.5:1 to about 2.5:1, about 0.5:1 to about 2:1, about 0.5:1 to about 1.5:1, or about 0.5:1 to about 1:1; from about 1:1 to about 6:1, about 1:1 to about 5:1, about 1:1 to about 4:1, about 1:1 to about 3:1, about 1:1 to about 2.5:1, about 1:1 to about 2:1, about 1:1 to about 1.5:1, or about 1:1 to about 1:1, including ranges or subranges thereof.

The fatty acid(s) present in the pet food composition may be in an amount from about 0.1 to about 5 wt %, based on the total weight of the pet food composition on a dry matter basis. For example, the pet food composition may contain fatty acid(s) in an amount from about 0.1 to about 4 wt %, about 0.1 to about 3 wt %, about 0.1 to about 2 wt %, about 0.1 to about 1 wt %; from about 0.2 to about 5 wt %, about 0.2 to about 4 wt %, about 0.2 to about 3 wt %, about 0.2 to about 2 wt %, about 0.2 to about 1 wt %; from about 0.5 to about 5 wt %, about 0.5 to about 4 wt %, about 0.5 to about 3 wt %, about 0.5 to about 2 wt %, about 0.5 to about 1 wt %; from about 0.75 to about 5 wt %, about 0.75 to about 4 wt %, about 0.75 to about 3 wt %, about 0.75 to about 2 wt %, about 0.75 to about 1 wt %; from about 1 to about 5 wt %, about 1 to about 4 wt %, about 1 to about 3 wt %, about 1 to about 2 wt %; from about 2 to about 5 wt %, about 2 to about 4 wt %, about 2 to about 3 wt %; from about 3 to about 5 wt %, about 3 to about 4 wt %, or any range or subranges thereof, based on the total weight of the pet food composition on a dry matter basis.

Fat can be supplied by any of a variety of sources known by those skilled in the art, including meat, meat by-products, canola oil, fish oil such as anchovy oil and menhaden oil, and plants. Meat fat sources include poultry fat, turkey fat, pork fat, lard, tallow, and beef fat. Plant fat sources include wheat, flaxseed, rye, barley, rice, sorghum, corn, oats, millet, wheat germ, corn germ, soybeans, peanuts, and cottonseed, as well as oils derived from these and other plant fat sources such as corn oil, soybean oil, cottonseed oil, palm oil, palm kernel oil, linseed oil, canola oil, rapeseed oil, and/or olestra.

In some cases, the fat in the compositions is crude fat. Crude fat may be included into the compositions in the amounts disclosed above with respect of the total fat, such as from about 8 to about 50 wt %, based on the total weight of the pet food composition on a dry matter basis. In some embodiments, the pet food composition comprises crude fat in an amount of about 10 to about 40 wt %, about 12 to about 35 wt %, about 14 to about 30 wt %, about 16 to about 24 wt %, based on the total weight of the pet food composition on a dry matter basis. In some cases, it may be preferable that about 50 wt % or more, about 60 wt % or more, about 70 wt % or more, about 80 wt % or more, or about 90 wt % or more of the total fat is obtained from an animal source. Alternatively, about 50 wt % or more, about 60 wt % or more, about 70 wt % or more, about 80 wt % or more, or about 90 wt % or more of the total fat may be obtained from a plant source.

The pet food compositions typically include protein in an amount ranging from about 15 to about 55 wt %, based on the total weight of the pet food composition on a dry matter basis. In some instances, the total amount of protein in the pet food composition is in a range from about 15 to about 50 wt %, about 15 to about 48 wt %, about 15 to about 46 wt %, about 15 to about 44 wt %, about 15 to about 42 wt %, about 15 to about 40 wt %, about 15 to about 38 wt %, about 15 to about 36 wt %, about 15 to about 34 wt %; from about 20 to about 55 wt %, about 20 to about 50 wt %, about 20 to about 48 wt %, about 20 to about 46 wt %, about 20 to about 44 wt %, about 20 to about 42 wt %, about 20 to about 40 wt %, about 20 to about 38 wt %, about 20 to about 36 wt %, about 20 to about 34 wt %; from about 25 to about 55 wt %, about 25 to about 50 wt %, about 25 to about 48 wt %, about 25 to about 46 wt %, about 25 to about 44 wt %, about 25 to about 42 wt %, about 25 to about 40 wt %, about 25 to about 38 wt %, about 25 to about 36 wt %, about 25 to about 34 wt %; from about 30 to about 55 wt %, about 30 to about 50 wt %, about 30 to about 48 wt %, about 30 to about 46 wt %, about 30 to about 44 wt %, about 30 to about 42 wt %, about 30 to about 40 wt %, about 30 to about 38 wt %, or about 30 to about 36 wt %, including ranges and subranges therebetween, based on the total weight of the pet food composition on a dry matter basis.

The protein of the pet food composition comprises one or more amino acids selected from tryptophan, taurine, histidine, carnitine, carnosine, alanine, cysteine, arginine, methionine (including DL-methionine, D-methionine, and L-methionine), tryptophan, lysine, asparagine, aspartate (aspartic acid), phenylalanine, valine, threonine, isoleucine, histidine, leucine, glycine, glutamine, tyrosine, homocysteine, ornithine, citruline, glutamate (glutamic acid), proline, and/or serine, and a combination of two or more thereof. The pet food composition may comprise two or more amino acids. For instance, the pet food composition may include two or more, three or more, four or more, five or more, six or more, seven or more, eight or more amino acids. In some embodiments, the pet food composition includes glycine and proline, and optionally one or more additional amino acids.

In some cases, the one or more amino acid(s) may comprise essential amino acids. Essential amino acids are amino acids that cannot be synthesized de novo, or in sufficient quantities by an organism and thus must be supplied in the diet. Essential amino acids vary from species to species, depending upon the organism's metabolism. For example, it is generally understood that the essential amino acids for dogs and cats (and humans) are phenylalanine, leucine, methionine, lysine, isoleucine, valine, threonine, tryptophan, histidine and arginine. In addition, taurine, while technically not an amino acid but a derivative of cysteine, is an essential nutrient for cats.

A portion of the protein in the composition may be digestible protein. For example, the composition may include an amount of protein, where about 40 wt % or more, about 50 wt % or more, about 60 wt % or more, about 70 wt % or more, about 80 wt % or more, about 90 wt % or more, about 95 wt % or more, about 98 wt % or more, or about 99 wt % or more of the protein is digestible protein. In some embodiments, e.g., when the composition desirable promotes weight loss, the portion of protein that is digestible protein is about 60 wt % or less, about 50 wt % or less, about 40 wt % or less, about 30 wt % or less, about 20 wt % or less, or about 10 wt % or less, based on the total amount of protein in the pet food composition on a dry matter basis. In further embodiment, the amount of protein that is digestible protein is about 10 to about 99 wt %, about 10 to about 95 wt %, about 10 to about 90 wt %, about 10 to about 70 wt %, about 10 to about 50 wt %, about 10 to about 30 wt %; about 30 to about 99 wt %, about 30 to about 95 wt %, about 30 to about 90 wt %, about 30 to about 70 wt %, about 30 to about 50 wt %; about 50 to about 99 wt %, about 50 to about 95 wt %, about 50 to about 90 wt %, about 50 to about 70 wt %; or about 70 to about 99 wt %, about 70 to about 95 wt %, about 70 to about 90 wt %, including ranges and subranges therein, based on the total amount of protein in the pet food composition on a dry matter basis.

Protein may be supplied by any of a variety of sources known by those of ordinary skill in the art including plant sources, animal sources, microbial sources or a combination of these. For example, animal sources may include meat, meat-by products, seafood, dairy, eggs, etc. Meats, for example, may include animal flesh such as poultry, fish, and mammals including cattle, pigs, sheep, goats, and the like. Meat by-products may include, for example, lungs, kidneys, brain, livers, stomachs and intestines. Plant protein includes, for example, soybean, cottonseed, and peanuts. Microbial sources may be used to synthesize amino acids (e.g., lysine, threonine, tryptophan, methionine) or intact protein such as protein from sources listed below.

Examples of protein or protein ingredients may comprise chicken meals, chicken, chicken by-product meals, lamb, lamb meals, turkey, turkey meals, beef, beef by-products, viscera, fish meal, enterals, kangaroo, white fish, venison, soybean meal, soy protein isolate, soy protein concentrate, corn gluten meal, corn protein concentrate, distillers dried grains, and/or distillers dried grain solubles and single-cell proteins, for example yeast, algae, and/or bacteria cultures.

The protein can be intact, completely hydrolyzed, or partially hydrolyzed. The protein content of foods may be determined by any number of methods known by those of skill in the art, for example, as published by the Association of Official Analytical Chemists in Official Methods of Analysis (“OMA”), method 988.05. The amount of protein in a composition disclosed herein may be determined based on the amount of nitrogen in the composition according to methods familiar to one of skill in the art.

The pet food compositions are typically formulated to include fiber in an amount from about 10 to about 60 wt %, based on the total weight of the pet food composition on a dry matter basis. For instance, the amount of fiber present in the pet food composition may be from about 10 to about 55 wt %, about 10 to about 50 wt %, about 10 to about 45 wt %, about 10 to about 40 wt %, about 10 to about 35 wt %, about 10 to about 30 wt %; from about 15 to about 60 wt %, about 15 to about 55 wt %, about 15 to about 50 wt %, about 15 to about 45 wt %, about 15 to about 40 wt %, about 15 to about 35 wt %, about 15 to about 30 wt %; from about 20 to about 60 wt %, about 20 to about 55 wt %, about 20 to about 50 wt %, about 20 to about 45 wt %, about 20 to about 40 wt %, about 20 to about 35 wt %, about 20 to about 30 wt %; from about 25 to about 60 wt %, about 25 to about 55 wt %, about 25 to about 50 wt %, about 25 to about 45 wt %, about 25 to about 40 wt %, about 25 to about 35 wt %; from about 30 to about 60 wt %, about 30 to about 55 wt %, about 30 to about 50 wt %, about 30 to about 45 wt %, about 30 to about 40 wt %; from about 35 to about 60 wt %, about 35 to about 55 wt %, about 35 to about 50 wt %, about 35 to about 45 wt %; from about 40 to about 60 wt %, about 40 to about 55 wt %, about 40 to about 50 wt %; from about 45 to about 60 wt %, about 45 to about 55 wt %; from about 50 to about 60 wt %, including ranges and subranges thereof, based on the total weight of the pet food composition on a dry matter basis.

The total amount of fiber present in the pet food composition generally comprises an amount of crude fiber and dietary fiber. The amount of crude fiber and/or dietary fiber may be present in the pet food compositions in any of the above amounts disclosed for the total amount of fiber. Crude fiber includes indigestible components contained in cell walls and cell contents of plants such as grains, e.g., hulls of grains such as rice, corn, and beans.

Dietary fiber refers to components of a plant that are resistant to digestion by an animal's digestive enzymes. Dietary fiber includes soluble fiber and insoluble fiber. Soluble fibers are resistant to digestion and absorption in the small intestine and undergo complete or partial fermentation in the large intestine, e.g., beet pulp, guar gum, chicory root, psyllium, pectin, blueberry, cranberry, squash, apples, oats, beans, citrus, barley, or peas. Insoluble fibers can be supplied by any of a variety of sources, including, for example, cellulose, whole-wheat products, wheat oat, corn bran, flax seed, grapes, celery, green beans, cauliflower, potato skins, fruit skins (e.g., pear skin), vegetable skins, peanut hulls, almond shell, walnut shell, pecan shell, citrus pulp, beet pulp, and soy fiber. In some embodiments, the dietary fiber may be chosen from pecan shell, citrus pulp, beet pulp, pear skin, and a combination of two or more thereof. Crude fiber includes indigestible components contained in cell walls and cell contents of plants such as grains, for example, hulls of grains such as rice, corn, and beans.

In some embodiments, the pet food composition has a weight ratio of insoluble fiber to soluble fiber from about 20:1 to about 8:1. For example, the pet food composition may have a weight ratio of insoluble fiber to soluble fiber from about 18:1 to about 8:1, about 16:1 to about 8:1, about 14:1 to about 8:1, about 12:1 to about 8:1, about 10:1 to about 8:1. The pet food composition may have a weight ratio of insoluble fiber to soluble fiber of about 11:1.

Additionally and/or alternatively, the fiber component of the pet food composition may comprise an acid detergent fiber and/or a neutral detergent fiber. In some instances, the pet food composition includes an acid detergent fiber and a neutral detergent fiber, e.g., in an amount that is from about 1 to about 20 wt %, based on the total weight of the pet food composition on a dry matter basis. For example, the pet food composition may include one of an acid detergent fiber and/or a neutral detergent fiber in an amount from about 1 to about 15 wt %, about 1 to about 12 wt %, about 1 to about 10 wt %, about 1 to about 8 wt %, about 1 to about 6 wt %, about 1 to about 5 wt %, about 1 to about 3 wt %; from about 3 to about 15 wt %, about 3 to about 12 wt %, about 3 to about 10 wt %, about 3 to about 8 wt %, about 3 to about 6 wt %, about 3 to about 5 wt %; about 5 to about 15 wt %, about 5 to about 12 wt %, about 5 to about 10 wt %, about 5 to about 8 wt %, about 5 to about 6 wt %; about 7 to about 15 wt %, about 7 to about 12 wt %, about 7 to about 10 wt %, about 7 to about 8 wt %; about 9 to about 15 wt %, about 9 to about 12 wt %, about 9 to about 10 wt %; about 11 to about 15 wt %, about 11 to about 13 wt %, or about 12 to about 15 wt %, including ranges and subranges thereof, based on the total weight of the pet food composition on a dry matter basis. In some embodiments, the pet food composition has a weight ratio of the acid detergent fiber to the neutral detergent fiber of from about 3:1 to about 1:3. In some embodiments, the weight ratio of the acid detergent fiber to the neutral detergent fiber is from about 2:1 to about 1:2 or about 1:1.

The pet food composition may further comprise ash. As described herein, ash consists of compounds that are not organic or water, generally produced by combustion of biological materials. The ash may be present in the pet food composition in an amount ranging from about 1 to about 10 wt %, based on the total weight of the food composition on a dry weight basis, including all amounts and sub-ranges there-between. In some embodiment, the ash may be present in the food composition in an amount ranging from about 1 to about 8 wt %, about 1 to about 6 wt %, about 1 to about 5 wt %, about 1 to about 4 wt %, about 1 to about 3 wt %, about 1 to about 2 wt %; from about 2 to about 10 wt %, about 2 to about 8 wt %, about 2 to about 6 wt %, about 2 to about 5 wt %, about 2 to about 4 wt %; from about 3 to about 10 wt %, about 3 to about 8 wt %, about 3 to about 6 wt %, about 3 to about 5 wt %; from about 4 to about 10 wt %, about 4 to about 8 wt %, about 4 to about 6 wt %; from about 5 to about 10 wt %, about 5 to about 8 wt %, or any range or subrange thereof, based on the total weight of the food composition on a dry weight basis.

The pet food composition may include carbohydrates, e.g., in an amount up to about 65 wt %, based on the total weight of the pet food composition on a dry matter basis. The term “carbohydrate” as used herein includes polysaccharides (e.g., starches and dextrins) and sugars (e.g., sucrose, lactose, maltose, glucose, and fructose) that are metabolized for energy when hydrolyzed. One skilled in the art could manipulate the texture of the final product by properly balancing carbohydrate sources. For example, short chain polysaccharides lend to be sticky and gluey, and longer chain polysaccharides are less sticky and gluey than the shorter chain; the desired texture of this hybrid food is achieved by longer chain polysaccharide and modified starches such as native or modified starches, cellulose and the like. The carbohydrate mixture may additionally comprise optional components such as added salt, spices, seasonings, vitamins, minerals, flavorants, colorants, and the like. The amount of the optional components is at least partially dependent on the nutritional requirements for different life stages of animals.

Carbohydrates can be supplied by any of a variety of sources known by those skilled in the art, including, but not limited to, oat fiber, cellulose, peanut hulls, beet pulp, parboiled rice, cornstarch, corn gluten meal, cereal, and sorghum. Grains supplying carbohydrates can include, but are not limited to, wheat, durum, semolina, corn, barley, and rice. In certain embodiments, the carbohydrate component comprises a mixture of one or more carbohydrate sources. Carbohydrates content of foods can be determined by any number of methods known by those of skill in the art.

Generally, carbohydrate percentage can be calculated as nitrogen free extract (“NFE”), which can be calculated as follows: NFE %=100%−(moisture %)−(protein %)−(fat %)−(ash %)−(crude fiber %) The amount of carbohydrate, e.g., calculated as NFE, present in the composition may be from an amount up to about 65 wt %, an amount up to about 60 wt %, an amount up to about 55 wt %, an amount up to about 50 wt %, an amount up to about 45 wt %, an amount up to about 40 wt %, an amount up to about 35 wt %, an amount up to about 30 wt %, an amount up to about 25 wt %, an amount up to about 20 wt %, an amount up to about 15 wt %, an amount up to about 10 wt %, an amount up to about 5 wt %; about 1 to about 65 wt %, about 1 to about 55 wt %, about 1 to about 50 wt %, about 1 to about 45 wt %, about 1 to about 40 wt %, about 1 to about 35 wt %; about 1 to about 30 wt %, about 1 to about 25 wt %, about 1 to about 20 wt %, about 1 to about 15 wt %, about 1 to about 10 wt %, about 1 to about 5 wt %; about 5 to about 65 wt %, about 5 to about 55 wt %, about 5 to about 50 wt %, about 5 to about 45 wt %, about 5 to about 40 wt %, about 5 to about 35 wt %; about 5 to about 30 wt %, about 5 to about 25 wt %, about 5 to about 20 wt %, about 5 to about 15 wt %; about 10 to about 65 wt %, about 10 to about 55 wt %, about 10 to about 50 wt %, about 10 to about 45 wt %, about 10 to about 40 wt %, about 10 to about 35 wt %; about 10 to about 30 wt %, about 10 to about 25 wt %; about 15 to about 65 wt %, about 15 to about 55 wt %, about 15 to about 50 wt %, about 15 to about 45 wt %, about 15 to about 40 wt %, about 15 to about 35 wt %; about 15 to about 30 wt %; about 20 to about 65 wt %, about 20 to about 55 wt %, about 20 to about 50 wt %, about 20 to about 45 wt %, about 20 to about 40 wt %, about 20 to about 35 wt %; about 25 to about 65 wt %, about 25 to about 55 wt %, about 25 to about 50 wt %, about 25 to about 45 wt %, about 25 to about 40 wt %, about 25 to about 35 wt %; about 30 to about 65 wt %, about 30 to about 55 wt %, about 30 to about 50 wt %, about 30 to about 45 wt %; about 35 to about 65 wt %, about 35 to about 55 wt %, about 35 to about 50 wt %; about 40 to about 65 wt %, about 40 to about 55 wt %, about 45 to about 65 wt %, about 45 to about 55 wt %; or about 50 to about 65 wt %, including ranges and subranges thereof, based on the total weight of the pet composition on a dry matter basis.

In certain embodiments, the pet food composition comprises moisture. The moisture may be present at various amounts or concentrations. In one embodiment, moisture may be present in an amount of from about 3 to about 20 wt %, based on the total weight of the pet food composition. For example, moisture may be present in an amount of about 3 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 10.5 wt %, about 11 wt %, about 11.5 wt %, about 12 wt %, about 12.5 wt %, about 13 wt %, about 13.5 wt %, about 14 wt %, about 14.5 wt %, or about 15 wt %, based on the total weight of the pet food composition. In another example, moisture may be present in an amount of from about 6% to about 12%, about 9% to about 13%, about 9% to about 11%, or about 9% to about 13%, based on the total weight of the pet food composition. In certain embodiments, moisture is present in an amount of about 5% to about 12%, about 6% to about 11%, or about 7% to about 10%, based on the total weight of the pet food composition. In further embodiments, moisture is present in an amount of about 65% to about 85%, about 60% to about 80%, or about 60% to about 75%, based on the total weight of the pet food composition.

The pet food compositions disclosed herein may be wet or dry compositions, and the ingredients can be either incorporated into the food composition and/or on the surface of any composition component, such as, for example, by spraying, agglomerating, dusting, or precipitating on the surface. Additionally, the pet food compositions may be formulated and produced to be in various forms and/or consistencies. For instance, the pet food compositions may, for example, be a dry, moist or semi-moist animal food composition. “Semi-moist” refers to a food composition containing from about 25 to about 35% moisture. “Moist” food refers to a food composition that has a moisture content of about 60 to 90% or greater. “Dry” food refers to a food composition with about 3 to about 12% moisture content and is often manufactured in the form of small bits or kibbles.

The food products may also include components of more than one consistency, for example, soft, chewy meat-like particles or pieces as well as kibble having an outer coating and an inner “core” component. In some embodiments, the pet food compositions may be in the form of a kibble or food kibble. As used herein, the term “kibble” or “food kibble” refers to a particulate pellet, e.g., like a component of feline or canine feeds. In some embodiments, a food kibble has a moisture, or water, content of less than 15% by weight. Food kibbles may range in texture from hard to soft. Food kibbles may range in internal structure from expanded to dense. Food kibbles may be formed by an extrusion process or a baking process. In non-limiting examples, a food kibble may have a uniform internal structure or a varied internal structure. For example, a food kibble may include a core and a coating to form a coated kibble. It should be understood that when the term “kibble” or “food kibble” is used, it can refer to an uncoated kibble or a coated kibble.

The composition of the present disclosure can additionally comprise other additives in amounts and combinations familiar to one of skill in the art. Such additives should be present in amounts that do not impair the purpose and effect provided by the disclosure. Examples of additives include substances with a stabilizing effect, organoleptic substances, processing aids, and substances that provide nutritional benefits.

Stabilizing substances may include, by way of example, substances that tend to increase the shelf life of the pet food composition. Other examples of other such additives potentially suitable for inclusion in the compositions of the disclosure include, for example, preservatives, antioxidants, synergists and sequestrants, packaging gases, stabilizers, emulsifiers, thickeners, gelling agents, and humectants. Examples of emulsifiers and/or thickening agents include gelatin, cellulose ethers, starch, starch esters, starch ethers, and modified starches. Additives for coloring, palatability, and nutritional purposes can include colorants, salts (including, but not limited to, sodium chloride, potassium citrate, potassium chloride, and other edible salts), vitamins, minerals, and flavoring. Other additives can include glucosamine, chondroitin sulfate, vegetable extracts, herbal extracts, etc.

The concentration of such additives in the pet food composition typically can be up to about 5 wt %, based on the total weight of the pet food composition on a dry matter basis. For example, the additives may be present in an amount from about 0.01 to about 5 wt %, about 0.01 to about 4 wt %, about 0.01 to about 4 wt %, about 0.01 to about 3 wt %, about 0.01 to about 2 wt %, about 0.01 to about 1 wt %; about 0.1 to about 5 wt %, about 0.1 to about 4 wt %, about 0.1 to about 4 wt %, about 0.1 to about 3 wt %, about 0.1 to about 2 wt %, about 0.1 to about 1 wt %; about 1 to about 5 wt %, about 1 to about 4 wt %, about 1 to about 4 wt %, about 1 to about 3 wt %, about 1 to about 2 wt %; about 2 to about 5 wt %, about 2 to about 4 wt %, about 2 to about 4 wt %, about 2 to about 3 wt %; about 3 to about 5 wt %, about 3 to about 4 wt %; or about 4 to about 5 wt %, based on the total weight of the pet food composition on a dry matter basis. In some embodiments, the concentration of such additives (particularly where such additives are primarily nutritional balancing agents, such as vitamins and minerals) is from about 0 to about 2.0% by weight, based on the total weight of the pet food composition on a dry matter basis. The amount of additives comprising vitamins may be in addition to the amount of vitamin B discussed above. In some embodiments, the concentration of such additives (again, particularly where such additives are primarily nutritional balancing agents) is from about 0 to about 1.0% by weight, based on the total weight of the pet food composition on a dry matter basis. Although the list of foregoing additives may be potentially suitable in some embodiments, one or more of the foregoing additives may be excluded from other embodiments of the pet food composition.

In specific embodiments, the pet food compositions and food products are formulated to address specific nutritional differences between species and breeds of animals, as well as one of more of the attributes of the animal. For example, cat foods, for example, are typically formulated based upon the life stage, age, size, weight, body composition, and breed.

Sources of proteins, carbohydrates, fats, vitamins, minerals, balancing agents, and the like, suitable for inclusion in the pet food compositions, and particularly in the food products to be administered in methods provided herein, may be selected from among those conventional materials known to those of ordinary skill in the art.

The pet food composition may be produced by various methods to achieve the desired pet food composition or desired form for the pet food composition. For example, dry food may be baked or extruded, then cut into individual shaped portions, such as kibbles. In some embodiments, the pet food composition may be prepared in a canned or wet form using conventional food preparation processes known to those of ordinary skill in the art. Typically, ground animal proteinaceous tissues are mixed with the other ingredients, such as cereal grains, suitable carbohydrate sources, fats, oils, and balancing ingredients, including special purpose additives such as vitamin and mineral mixtures, inorganic salts, cellulose, beet pulp and the like, and water in an amount sufficient for processing. The ingredients are mixed in a vessel suitable for heating while blending the components. Heating the mixture is carried out using any suitable manner, for example, direct steam injection or using a vessel fitted with a heat exchanger. Following addition of all of the ingredients of the formulation, the mixture may be heated to a temperature of from 50 OF to 212° F. Although temperatures outside this range can be used, they may be commercially-impractical without the use of other processing aids. When heated to the appropriate temperature, the material will typically be in the form of thick liquid, which is dispensed into cans. A lid is applied and the container is hermetically sealed. The sealed can is then placed in convention equipment designed for sterilization of the contents. Sterilization is usually accomplished by heating to temperatures of greater than 230° C. for an appropriate time depending on the temperature used, the nature of the composition, and related factors. The pet food compositions and food products of the present disclosure can also be added to or combined with food compositions before, during, or after their preparation.

In some embodiments, the food products may be prepared in a dry form using convention processes known to those of ordinary skill in the art. Typically, dry ingredients, including dried animal protein, plant protein, grains and the like are ground and mixed together. Liquid or moist ingredients, including fats, oils water, animal protein, water, and the like are added combined with the dry materials. The specific formulation, order of addition, combination, and methods and equipment used to combine the various ingredients can be selected from those known in the art. For example, in certain embodiments, the resulting mixture is process into kibbles or similar dry pieces, which are formed using an extrusion process in which the mixture of dry and wet ingredients is subjected to mechanical work at high pressure and temperature, forced through small openings or apertures, and cut off into the kibbles, e.g., with a rotating knife. The resulting kibble can be dried and optionally coated with one or more topical coatings comprising, e.g., flavors, fats, oils, powdered ingredients, and the like. Kibbles may also be prepared from dough by baking, rather than extrusion, in which the dough is placed into a mold before dry-heat processing.

In preparing a composition, any ingredient generally may be incorporated into the composition during the processing of the formulation, e.g., during and/or after mixing of the other components of the composition. Distribution of these components into the composition can be accomplished by conventional means. In certain embodiments, ground animal and/or poultry proteinaceous tissues are mixed with other ingredients, including nutritional balancing agents, inorganic salts, and may further include cellulose, beet pulp, bulking agents and the like, along with sufficient water for processing.

### EXAMPLES

### Example 1—Pet Food Compositions

A positive control pet food composition and a test pet food composition were formulated to meet or exceed AAFCO nutritional recommendations. The finished kibbles were generated by extrusion, dried, and then coated with palatants. The test composition differed from the control composition through the inclusion of 2% fish collagen hydrolysate at the grain mix stage and by reducing the level of rice protein concentrated in the control food in order to keep protein, carbohydrate, and fat levels similar in both foods. The ingredients in both compositions are shown below in Table 1, and the proximate analyses of both compositions are shown in Table 2 below. An amino acid analysis for each composition is shown below in Table 3.

TABLE 1
Formulation comparison of positive control
and test pet food compositions

| | Positive control | Test |
|---|---|---|
| Ingredient | composition | composition |
| Rice, brown or brewers | 62.6 | 62.6 |
| Egg, dried pelleted | 9.7 | 9.7 |
| Rice protein conc. pwdr. | 4.86 | 2.86 |
| Soybean oil, refined | 4.75 | 4.75 |
| Flax seed | 3.17 | 3.17 |
| Palatant | 3 | 3 |
| Beet pulp, pelleted | 2.5 | 2.5 |
| Fish oil | 2.25 | 2.25 |
| Coconut oil | 1.5 | 1.5 |
| Lactic acid blend, 84% | 1.2 | 1.2 |
| Dicalcium phosphate, | 2.87 | 2.87 |
| potassium chloride, and | | |
| calcium carbonate, | | |
| sodium chloride | | |
| Fruit and vegetable blend | 0.5 | 0.5 |
| Lipoic acid, alpha, 5% | 0.3 | 0.3 |
| Vitamin and mineral | 0.25 | 0.25 |
| premixes | | |
| Vitamin E, adsorbate 50% | 0.15 | 0.15 |
| Taurine | 0.14 | 0.14 |
| Choline chloride 70% | 0.10 | 0.10 |
| Methionine | 0.07 | 0.07 |
| Antioxidants | 0.04 | 0.04 |
| Natural flavorings | 0.03 | 0.03 |
| Fish collagen hydrolysate | — | 2 |
| Total | 100 | 100 |

TABLE 2
Proximate analyses of positive control
and test pet food compositions

| | Positive control | Test |
|---|---|---|
| | composition | composition |
| Analyte | (%) | (%) |
| Ash | 4.33 | 4.25 |
| Fat crude | 17.04 | 17.23 |
| Protein crude | 15.88 | 16.25 |
| Moisture | 7.54 | 6.85 |
| Fiber crude | 1.2 | 1 |
| NFE | 54.01 | 54.42 |
| Insoluble fiber | 3.8 | 3.8 |
| Soluble fiber | 0.8 | 0.8 |
| Total dietary fiber | 4.6 | 4.6 |
| Omega 3 sum | 1.76 | 1.86 |
| Omega 6 sum | 3.78 | 3.99 |
| C20:5 EPA omega 3 | 0.37 | 0.4 |
| C22:5 DPA omega 3 | 0.05 | 0.05 |
| C22:6 DHA omega 3 | 0.24 | 0.25 |

TABLE 3
Amino acid analyses of positive control
and test pet food compositions

| | Positive control | Test | |
|---|---|---|---|
| | composition | composition | |
| Amino Acid | (%) | (%) | % Difference |
| Alanine | 0.87 | 0.97 | 10.87 |
| Arginine | 1.03 | 1.09 | 5.66 |
| Aspartic acid | 1.42 | 1.41 | −0.71 |
| Cystine | 0.29 | 0.28 | −3.51 |
| Glutamic acid | 2.39 | 2.35 | −1.69 |
| Glycine | 0.66 | 1.09 | 49.14 |
| Histidine | 0.36 | 0.36 | 0 |
| Hydroxyproline | 0.06 | 0.13 | 73.68 |
| Isoleucine | 0.69 | 0.64 | −7.52 |
| Leucine | 1.25 | 1.17 | −6.61 |
| Lysine | 0.83 | 0.87 | 4.71 |
| Methionine | 0.49 | 0.5 | 2.02 |
| Phenylalanine | 0.79 | 0.74 | −6.54 |
| Proline | 0.71 | 0.8 | 11.92 |
| Serine | 0.85 | 0.91 | 6.82 |
| Threonine | 0.61 | 0.61 | 0 |
| Tryptophan | 0.22 | 0.21 | −4.65 |
| Tyrosine | 0.49 | 0.42 | −15.39 |
| Valine | 0.94 | 0.91 | −3.24 |

Food analyses: Both the positive control pet food composition and the test pet food composition had similar macronutrient and omega 3 and omega 6 fatty acid levels, as shown in Table 2. However, the amino acids (both essential and non-essential) profile in both foods showed certain differences. Specifically, proline, hydroxyproline, and glycine levels were higher in the test pet food composition due to the inclusion of the fish collagen hydrolysate.

### Example 2—Effects of Compositions on Dermatological Problems

Experimental feeding design: This study was performed on a total of 30 dogs, wherein 15 dogs were clinically diagnosed with dermatological problems and 15 healthy dogs were pair-matched by gender and age. All dogs' ages ranged from 2 years, 10 months to 12 years, 2 months, and their body weights ranged from 4.5 kg to 15.4 kg. All animals were of mixed gender and neutered or spayed. This feeding study was performed using a crossover experimental design. Briefly, all 30 dogs were pre-fed with an adult maintenance food for 28 days and then divided into two groups by matching age, gender, and phenotype (dermatological problems or healthy) parameters. Group 1 was fed with the positive control pet food composition as described above in Example 1 for 42 days, and Group 2 was fed with the test pet food composition as described above in Example 1 for 42 days (Phase 1). After 42 days, Group 1 was switched to the test food composition, and Group 2 was fed the positive control pet food composition for another 42 days (Phase 2), without a washout period in between. Blood samples were collected at three time points: end of pre-feed, end of Phase 1, and end of Phase 2. Dermatological health and symptoms were assessed by a veterinarian using a prescribed questionnaire at the end of the pre-feed, the end of Phase 1, and the end of Phase 2 to determine the severity of pruritus, erythema, skin and car secretions, and alopecia in the dermatitis dogs.

Statistical Analysis: All 15 dogs that had been clinically diagnosed with dermatological problems were included for the questionnaire-based assessment analyses. The categorical data from the veterinarian questionnaire was converted into numerical data before calculating the treatment effect on improvement in the percentage of canines alleviating atopic dermatitis symptoms under four categories: pruritus, erythema, alopecia, and skin and ear secretions. In each category, there were a set of questions answered by the veterinarian based on their assessment of each dog and measured as none, mild, moderate, and severe symptoms. These categorical measurements were converted into numerical data such that none=0, mild=1, moderate=2, and severe=3. Later, these measurements were summed in each category by animal and treatment, to calculate the percentage of canine improvement under these four categories.

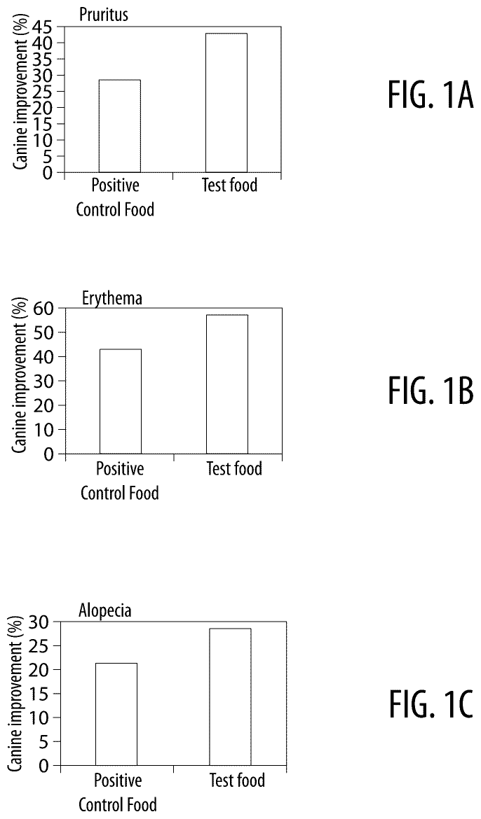

Results: As shown in FIG. 1, the test pet food composition was shown to reduce pruritus (FIG. 1A), erythema (FIG. 1B), and alopecia (FIG. 1C) scores, and it increased the response rate (improvement %) of dogs to 42.85%, 57.14%, and 28.57%, respectively, when compared to the control pet food composition, wherein the improvement % was 28.57% for pruritus, 42.85% for erythema, and 21.42% for alopecia. No impact was observed for skin or ear secretions. In the management of atopic dermatitis, the reduction of pruritus and erythema specifically are notable because of the itching and redness in the skin, which further deteriorates the skin health with hair loss, if the symptoms continue to persist. The test food composition reduced pruritus, erythema, and hair loss robustly when compared with the positive control food composition. This suggests that the test food composition improves the quality of a pet's life by reducing scratching and other problem behaviors associated with chronic pruritus.

### Example 3—Digestibility and Palatability Analyses

Digestibility and palatability tests were run following the AAFCO protocol. The results of the digestibility analysis are shown in Table 4 below, and the results of the palatability analysis are shown in Table 5 below.

TABLE 4
Digestibility analyses of positive control
and test pet food compositions

| | Positive | |
|---|---|---|
| | control | Test |
| | composition | composition |
| Nutrient | (%) | (%) |
| Apparent dry matter digestibility | 88.6 | 88.8 |
| Apparent protein digestibility | 81.5 | 82.8 |
| True protein digestibility | 91.0 | 92.2 |
| Apparent fat digestibility | 93.3 | 93.4 |
| Apparent carbohydrate digestibility | 95.0 | 95.0 |
| Metabolizable energy, kcal/kg | 4215 | 4205 |

TABLE 5
Palatability analyses of positive control
and test pet food compositions

| Intake of | Intake | Test | | |
|---|---|---|---|---|
| positive | of test | composition | p-value | p-value |
| control | composition | intake | (2- | (1- |
| composition (g) | (g) | ratio | tailed) | tailed) |
| 90.52 | 106.18 | 0.53 | 0.35 | 0.17 |

As shown above in Tables 4 and 5, no considerable differences were found in the digestibility test analyses between the positive control and test pet food compositions. Similarly, no significant difference was observed in the palatability test analyses between the positive and test pet food compositions.

### Example 4—Gene Expression Analysis

The gene expression of RNA samples was evaluated for the pets involved in the feeding experiment described in Example 2 above when blood samples were collected. Total RNA was isolated from whole blood collected in PAXgene blood RNA tubes. RNA integrity was measured using the Agilent Bioanalyzer 2100, and the QUBIT® Broad Range Assay kit was used to measure the sample concentration of total RNA. The Nanostring NCOUNTER® Canine Immuno-oncology (IO) panel containing 800 genes was used to measure the immune response, and data were normalized to a specific set of housekeeping genes using NanoString's nSolver data analysis software.

Statistical analysis: All 30 dogs were included for gene expression data analyses. Gene expression count data was normalized with housekeeping gene(s) by using the nanostring nSolver tool, and the resultant normalized data was log transformed before performing statistical analyses. In order to assess the food effect on the gene expression data, mixed model analysis was performed by using treatment (food) as a fixed effect and animal as a random effect, followed by pairwise comparisons using Tukey post-hoc test (JMP Pro v.17.0).

Results: Based on the gene expression analyses, the test food significantly decreased the expression of circulating PLAUR (CD87), TSC2, ITGAX (CD11c), ITGB2 (CD18), and PRKCE, when compared to a baseline and decreased numerically when compared to the dogs fed the positive control pet food composition. Additionally, the test food significantly increased the expression of circulating CD83 and S100A4 when compared to a baseline and increased numerically when compared to the dogs fed the positive control pet food composition.

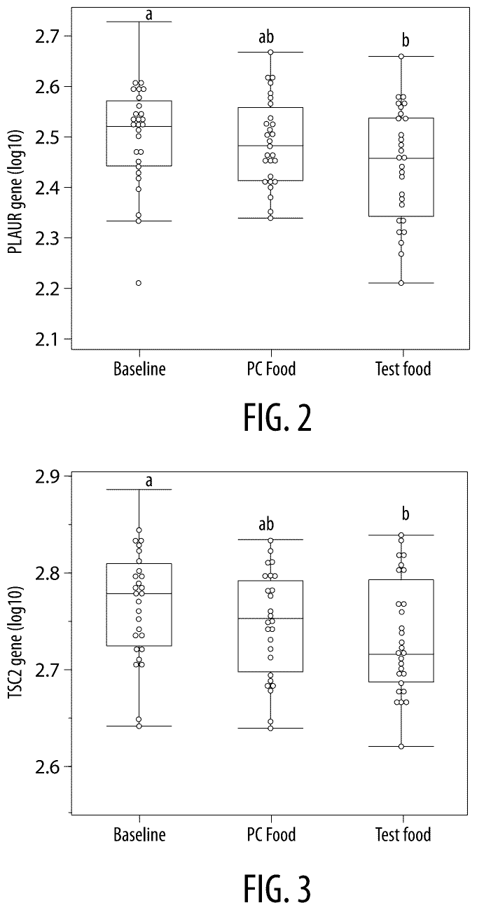

As shown in FIG. 2, dogs consuming the test pet food composition had decreased expression levels of PLAUR as compared to the baseline measurement, as well as decreased expression of PLAUR when compared to the dogs fed the positive control pet food composition. Given PLAUR's association as discussed herein with higher median overall survival of cancer patients before or during immune checkpoint inhibitor therapy, this result suggests that the pet food compositions disclosed herein also have the potential to provide nutritional support for a better outcome to cancer patients undergoing immune checkpoint inhibitor therapy.

As shown in FIG. 3, dogs consuming the test pet food composition had decreased expression levels of TSC2 as compared to the baseline measurement, as well as decreased expression of TSC2 when compared to the dogs fed the positive control pet food composition. Because TSC2 acts a negative regulator of mTORC1 signaling, down-regulation of TSC2 by the pet food compositions disclosed herein compared with a baseline suggests an increasing activity of mTORC1 signaling, which is necessary for the activation and entry of hair follicle stem cells into the anagen phase of hair growth, as discussed above.

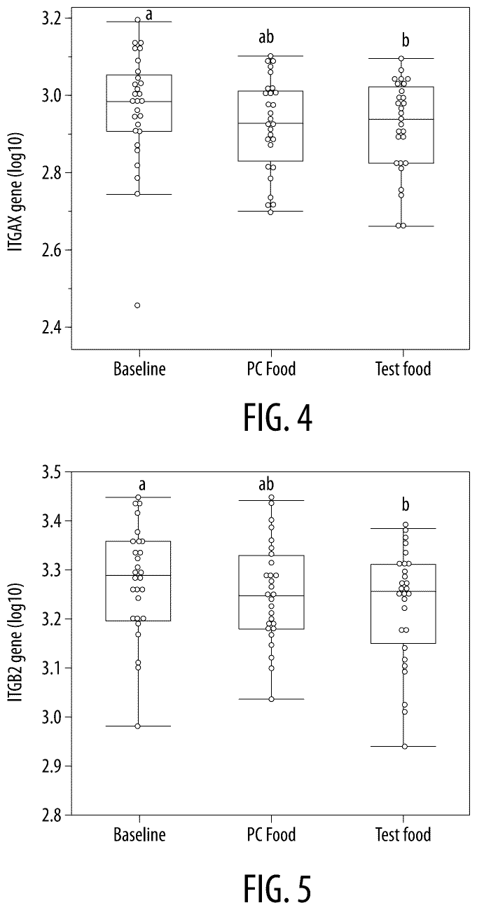

As shown in FIG. 4, the pet food compositions disclosed herein significantly reduced ITGAX gene expression as compared to a baseline measurement, as well as decreased expression of ITGAX when compared to the dogs fed the positive control pet food composition, indicating that the pet food composition disclosed herein reduced pruritus scores through reducing dendritic cells in the inflamed skin region and thus increasing the response rate to alleviate pruritus.

As show in FIG. 5, the test pet food composition also significantly reduced expression of ITGB2 as compared to a baseline measurement, as well as decreased expression of ITGB2 when compared to the dogs fed the positive control pet food composition. As discussed above, expression of ITGB2 surface molecules is significantly higher in atopic dermatitis dogs as well as atopic dermatitis dogs with purulent dermatitis compared with healthy dogs; therefore, decreased expression of ITGB2 is indicative of alleviating atopic dermatitis.

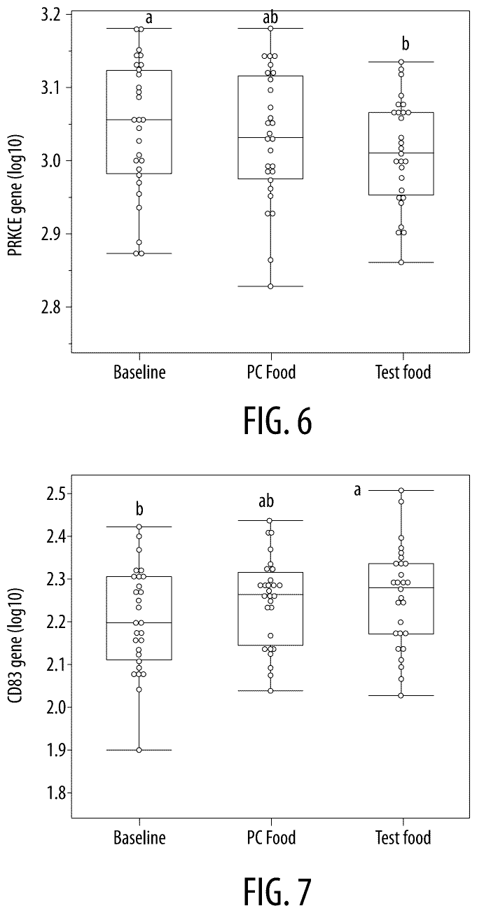

As shown in FIG. 6, the pet food composition disclosed herein significantly reduced the expression of PRKCE compared with a baseline and was numerically decreased compared with a positive control food, indicating a reduction of inflammatory disorders of microbial origin. In addition, Based on this information, the pet food composition disclosed herein has the potential to provide nutritional support for better outcomes to cancer patients as well preventing drug resistance.

As shown in FIG. 7, the pet food composition disclosed herein significantly increased the expression of CD83 compared with the baseline and numerically increased when compared with the positive control pet food composition. As discussed above, CD83 is a potential candidate for “pro-resolution” therapy for chronic inflammatory diseases and is involved in the resolution of inflammation, reducing skin inflammation and development of allergy contact dermatitis and improving cutaneous wound healing.

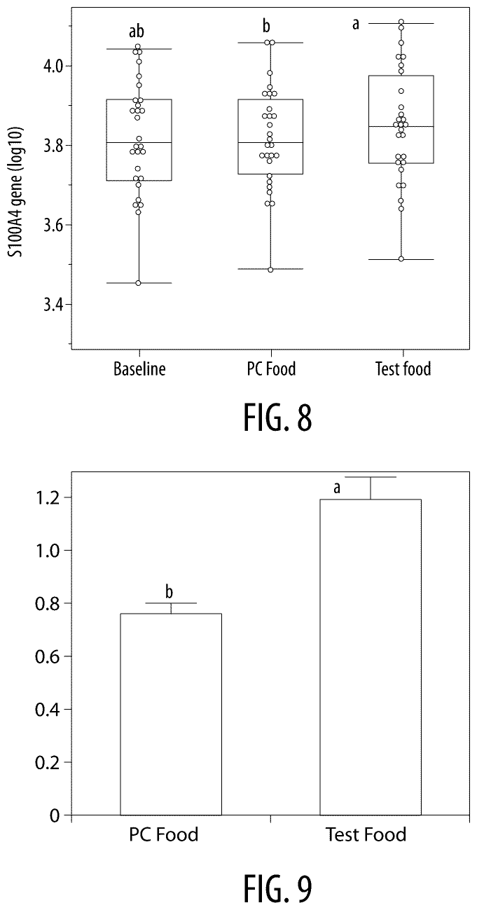

As shown in FIG. 8, the pet food composition disclosed herein significantly increased the expression of S100A4 compared with the positive control pet food composition and numerically increased compared with the baseline. As discussed above, S100A4 is involved in follicle regeneration.

Finally, as shown in FIG. 9, the dogs fed with the pet food composition disclosed herein show significant increase of circulating trans-4-hydroxyproline (physiological isomeric form of hydroxyproline) compared with the positive control food, suggesting post-translational hydroxylation of dietary collagen from the ingredient fish collagen hydrolysate. Trans-4-hydroxyproline is also involved in collagen synthesis and stability and scavenging reactive oxygen species. In addition, a study demonstrated that dietary supplementation of hydroxyproline enhances growth performance, collagen synthesis and muscle quality in triploid crucian carp Carassius auratus (Cao et al., 2022). Another study reported the hair growth promoting effects of fish collagen peptides in rodent models by modulating the Wnt/beta catenin and BMP signaling pathways (Hwang et al., 2022). Further, it was demonstrated in the rodent model that oral administration of collagen hydrolysate results in di- or tripeptides (or larger peptides) absorbed and detected in the circulation system (Osawa et al., 2018).

Overall, this study showed that the test pet food composition with fish collagen hydrolysate robustly altered systemic gene expression levels involved in immune modulation, cutaneous wound healing processes, and hair follicle regeneration in dogs with dermatological problems. The test pet food composition also alleviated signs of atopic dermatitis, including pruritus, erythema and alopecia, to improve overall quality of life of the dogs (FIG. 1A-1C; FIG. 10).

### REFERENCES

1. Mathay, C. et al., Transcriptional profiling after lipid raft disruption in keratinocytes identifies critical mediators of atopic dermatitis pathways, J. Invest. Derm. 2011, 131:46-58.
2. Nousbeck, J. et al., Peripheral blood gene expression profile of infants with atopic dermatitis, JID Innovations 2023, 3:100165.
3. Chen, W. et al., The PLAUR signaling promotes chronic pruritus, FASEB J. 2022, 36: e22368.
4. Loosen, S. H. et al., Serum levels of soluble urokinase plasminogen activator receptor predict tumor response and outcome to immune checkpoint inhibitor therapy, Front. Oncol. 2021, 11:646883.
5. Tu, W. et al., mTOR signaling in hair follicle and hair diseases: recent progress, Frontiers in Medicine 2023, 10:1209439.
6. Deng, Z. et al., mTOR signaling promotes stem cell activation via counterbalancing BMP-mediated suppression during hair regeneration, J. Mol. Cell Biology 2015, 7 (1): 62-72.
7. Xu, J. et al., The cytokine TGF-beta induces Interleukin-31 expression from dermal dendritic cells to activate sensory neurons and stimulate wound itching, Immunity 2020, 53:371-83.
8. Fagerholm, S. C. et al., Beta2-integrins and interacting protein in leucocyte trafficking, immune suppression and immunodeficiency disease, Frontiers Immunol. 2019, 10:254.
9. Taszkun, I., Assessment of CD11b and CD11/18 integrin expression on leukocytes of dogs with atopic dermatitis, Bull. Vet. Inst. Pulaway 2014, 58:99-103.
10. Webb, B. L. J. et al., Protein Kinase C isoenzymes: a review of their structure, regulation and role in regulating airways smooth muscle tone and mitogenesis, British J. Pharmacol. 2000, 130:1433-52.
11. Aksoy, E. et al., Protein Kinase C epsilon: a new target to control inflammation and immune-mediated disorders 2004, 36:183-88.
12. Gorin, M. A. et al., Protein Kinase C epsilon: an oncogene and emerging tumor biomarker, Molecular Cancer 2009, 8:9.
13. Nicholson, R. et al., Protein Kinase C Epsilon overexpression is associated with poor patient outcomes in AML and promotes daunorubicin resistance through p-glycoprotein mediated drug efflux, Frontiers Oncol. 2022, 12:840046.
14. Peckert-Maier, K. et al., Tilting the balance: therapeutic prospects of CD83 as a checkpoint molecule controlling resolution of inflammation, Inter. J. Mol. Sciences 2022, 23:732.
15. Royzman, D. et al., Soluble CD83 improves and accelerates wound healing by the induction of pro-resolving macrophages, Frontiers Immunol. 2022, 13:1-12647.
16. Ito, M. et al., Expression of calcium-binding S100 proteins A4 and A6 in regions of the epithelial sac associated with the onset of hair follicle regeneration, J. Invest. Dermatol. 2001, 116 (6): 956-63.
17. Wang, H. et al., Activation of the P13K/Akt/mTOR/p70S6K pathway is involved in S100A4-induced viability and migration in colorectal cancer cells, Intl. J. Med. Sci. 2014, 11:841-49.
18. Cao, S. et al., Dietary supplementation with hydroxyproline enhances growth performance, collagen synthesis and muscle quality of Carassius auratus Triploid, Frontiers Physiol. 2022, 13:913800.
19. Hwang, S. B. et al., Hair-growth-promoting effects of the fish collagen peptide in human dermal papilla cells and C57BL/6 mice modulating Wnt/beta-catenin and BMP signaling pathways, Inter. J. Mol. Sciences 2022, 23:11904.
20. Osawa, Y. et al., Absorption and metabolism of orally administered collagen hydrolysates evaluated by the vascularly perfused rat intestine and liver in situ, Biomedical Research 2018, 39 (1): 1-11.
21. Mihatsch, P. et al., Soluble CD83 inhibits skin inflammation to chemical sensitizers, J. Investigative Derm. 2016, 136, S224, Abstract #370.

What is claimed is:

1. A pet food composition comprising:
an effective amount of fish collagen hydrolysate.

2. The pet food composition according to claim 1, wherein the fish collagen hydrolysate is present in an amount ranging from about 0.5% to about 5%, by weight based on the total weight of the pet food composition.

3. The pet food composition according to claim 1, wherein the pet food composition comprises at least one of glycine present in an amount greater than about 0.7%, hydroxyproline present in an amount greater than about 0.1%, or proline present in an amount greater than about 0.7%, wherein all weights are based on the total weight of the pet food composition.

4. The pet food composition according to claim 1, wherein the pet food composition is a dog food composition.

5. The pet food composition according to claim 1, wherein the pet food composition is a nutritionally complete diet.

6. The pet food composition according to claim 1, wherein the pet food composition is a treat or a supplement.

7. A method of treating an immune disorder in a companion animal in need thereof, the method comprising orally administering to the companion animal a pet food composition comprising an effective amount of fish collagen hydrolysate.

8. The method according to claim 7, wherein the fish collagen hydrolysate is present in the pet food composition an amount ranging from about 0.5% to about 5%, by weight based on the total weight of the pet food composition.

9. The method according to claim 7, wherein the pet food composition comprises at least one of glycine present in an amount greater than about 0.7%, hydroxyproline present in an amount greater than about 0.1%, or proline present in an amount greater than about 0.7%, wherein all weights are based on the total weight of the pet food composition.

10. The method according to claim 7, wherein the immune disorder is atopic dermatitis.

11. The method according to claim 10, wherein the atopic dermatitis is characterized by at least one of pruritus, erythema, alopecia, ear secretions, or skin secretions.

12. The method according to claim 7, wherein the method decreases expression of at least one gene selected from PLAUR, TSC2, ITGAX, ITGB2, or PRKCE in the companion animal, or wherein the method decreases expression of at least two genes selected from PLAUR, TSC2, ITGAX, ITGB2, or PRKCE in the companion animal.

13. The method according to claim 7, wherein the method increases expression of at least one gene selected from CD83 or S100A3 in the companion animal.

14. The method according to claim 7, wherein the method increases trans-4-hydroxyproline in the companion animal.

15. The method according to claim 7, wherein the method improves cutaneous wound healing in the companion animal or wherein the method improves hair follicle regeneration in the companion animal.

16. A method of treating cancer in a companion animal in need thereof, the method comprising administering to the companion animal a pet food composition comprising an effective amount of fish collagen hydrolysate.

17. The method according to claim 16, wherein the companion animal is undergoing immune checkpoint inhibitor therapy.

18. The method according to claim 16, wherein the fish collagen hydrolysate is present in an amount ranging about 0.5% to about 5%, by weight based on the total weight of the pet food composition.

19. The method according to claim 16, wherein the pet food composition comprises at least one of glycine present in an amount greater than about 0.7%, hydroxyproline present in an amount greater than about 0.1%, or proline present in an amount greater than about 0.7%, wherein all weights are based on the total weight of the pet food composition.

20. A method for alleviating at least one of pruritus, erythema, or alopecia in a companion animal with atopic dermatitis, the method comprising:
orally administering to the companion animal a pet food composition according to claim 1.
